(19) United States
(12) Patent Application Publication
(10) Pub. No.: US 2012/0004373 A1
(43) Pub. Date: Jan. 5, 2012

(54) POWDER COATING COMPOSITIONS CROSS-LINKED WITH NON CYANURATE POLYEPOXIDES

(76) Inventors: Damiano Beccaria, Cuneo (IT); Imir Bejko, Cuneo (IT); Andrea Capra, Cuneo (IT); Enrico Galfre', Cuneo (IT); Lino Natale Carlevaris, Cuneo (IT)

(21) Appl. No.: 12/063,609

(22) Filed: Feb. 12, 2008

(30) Foreign Application Priority Data
Aug. 23, 2006 (EP) PCT/EP2006/008269

(51) Int. Cl. C09D 167/00

(52) U.S. Cl. 525/438; 525/437

(57) ABSTRACT

The present invention relates to powder coating compositions and to components and ingredients for incorporation therein, suitable for fast curing schedule and with excellent resistance to outside aging. Non-isocyanurate polyepoxide cross-linking reagents can be used, provided the nature of the carboxylated polyester resin is formed of at least 30 mole % aromatic acid and the chain of the carboxyl terminated polyester also incorporates a moiety derived from 1,4 cyclohexanedicarboxylic acid. The powder coating composition can be cured for 90 seconds at a temperature of 250° C. or 55 seconds at 270° C. or 20 seconds in an induction oven at a temperature of 300° C. in the presence of a catalyst.

The present invention relates to powder coating compositions and to components and ingredients for incorporation therein, suitable for fast curing schedule and with excellent resistance to outside aging.

Powder coating technology is generally a well-known and well defined art and has significant advantages over “wet” technologies for painting and spraying. The principle behind thermoset powder coating decoration is that the powder coating is formulated by dispersing coloring agents or pigments within a matrix of cross-linkable material, grinding the material to a powder, applying the powder to a surface to be coated and then heating or baking to cause the powder particles to coalesce to form a layer on the surface to be decorated and thereafter causing or allowing curing or crosslinking to take place to form a thermoset layer. Based on these principals the skilled artisan is always searching the best compromise between cure/production speed and appearance of the thermoset formulations.

A major challenge in the development of powder coatings, however, is the need to satisfy a number of seemingly conflicting requirements. One of the essential requirements of a powder coating is that it should be curable/cross-linkable. In the majority of cases this means the incorporation of a cross-linking agent. The proportion of cross-linking agents should be sufficient to ensure integrity of the coating after a relatively short period of bake. It is desirable that the baking should be as fast as possible to minimize energy costs. The dilemma is that if the proportion of cross-linking agent is high enough to induce a fast cross-linking reaction, the cross-linking could occur at too early a stage in the baking process, with a result that the powder particles will not have fully coalesced and “leveled”. This will result in the production of an article with an unacceptable finish, usually characterized by “orange peel”, or in extreme cases, a degree of cracking where cross-linking continues after termination of the baking process.

Relatively high levels of cross-linking agent, or alternatively, a low threshold for cross-linking, will generally tend to result in production and storage problems. One of the ways in which the powder coating material is produced is by extruding a mixture of pigment and coloring material together with a powder coating resin and then extruding the resultant mixture to produce a substantially homogenous dispersion of pigment or coloring material within the resin. The extrudate is cooled and then crushed or ground to a fine powder. The extrusion step involves heating the feed to the extruder screw. The act of extrusion results in a working of the polymeric material constituting the matrix material, resulting in additional heat that may be sufficient to produce or initiate local cross-linking. This can result in gel particles. If this proceeds to any significant degree, then the resultant ground powder, when subjected to the sintering process will not freely coalesce to form the coating, but will tend to agglomerate again resulting in the production of an unsatisfactory finish.

A thermosetting powder coating with outstanding properties for exterior end applications is typically based on a polyester resin. Polyester powder coatings are typically formulated with polyepoxide and beta hydroxyalkyl amide type cross-linking compounds. The technology surrounding these materials is generally well known and has been discussed and considered in a number of articles and prior patent specifications.

Powder coating compositions which include a carboxyl terminated polyester and triglycidyl isocyanurate (TGIC) as a cross-linking agent produce good results. Such compositions have been found to provide the desired combination of relatively high glass transition temperature of the powder to provide good stability during storage and full coalescence of the particles prior to the onset of the cure. The commercial application of TGIC is now questionable, since the material has been found to be particularly toxic. TGIC has been classified accordingly to European Legislation as a Toxic, Irritant and Mutagenic Class 2 material. It is classified harmful to aquatic organisms because of possible long-term adverse effects in the aquatic environment. A TGIC and powder composition incorporating it now requires labeling as toxic with the “skull and crossbones” symbol. Workplace precautions generally associated with the handling of toxic material has significantly reduced the attractiveness of such powder coating materials in much of Europe.

Attempts have thus been made to replace TGIC with other crosslinking agents for polyesters bearing carboxyl groups. Among these, acrylic copolymers bearing epoxide groups have been used. However, binders containing these two types of compounds give coatings whose impact strength and flexibility are too low to be used in post sintered coated metal plates, known as coil coating technology. Attempts have also been made to use beta-hydroxyalkylamides as crosslinking agents for polyesters bearing carboxyl groups. The hydroxyl group located in the beta position relative to the amide group is highly reactive in the esterification of the carboxyl group in the polyesters, which leads to problems as in regards to the rate of crosslinking of compositions containing this type of crosslinking agent. The reason for this is that, since this rate is high, the coating does not have enough time to spread out correctly when it melts, which leads to surface defects such as the formation of an orange-peel skin. In addition, this esterification is accompanied by a release of water, which does not have time to escape from the coating as it hardens, which also leads to surface defects.

Patent EP 0 322 834, for example, describes thermosetting powder compositions essentially containing a polyester bearing carboxyl groups and a beta-hydroxyalkylamide, which is applied to a substrate and is then crosslinked at a temperature of 160 to 200° C. Despite the presence of benzoin in these compositions, which is added as degassing agent, the bubbles of water and air remain trapped in the hardened coating after it has melted and crosslinked, especially if the coating is relatively thick. In addition, the flow of the powder when it melts is not optimal.

Patent application WO 91/14745 describes thermosetting powder compositions containing an amorphous polyester containing carboxyl groups, a semi-crystalline polyester containing carboxyl groups and a crosslinking agent. 10 to 40% by weight of the semi-crystalline polyester is preferably used relative to the polyesters as a whole, and the crosslinking agent can be a beta-hydroxyalkylamide. The presence of the semi-crystalline polyester in these compositions improves the mechanical properties of the coatings they provide. However, the presence of these semi-crystalline polyesters also increases the rate of hardening of these compositions, which could be a factor which disfavors the satisfactory flowing and degassing of these compositions when they melt, leading to surface defects in the coatings.

Patent application EP 0 668 895 also describes thermosetting powder compositions containing a polyester bearing carboxyl groups and a beta-hydroxyalkylamide. The polyesters of that patent application have a functionality of carboxyl groups of less than 2, obtained by adding monofunctional acids or alcohols during the synthesis of the polyester. By virtue of this reduced functionality, the polyester is less reactive, which makes the powder flow better when it melts and allows the bubbles of air and of water vapor to escape from the coating before it hardens, unlike the compositions in patent applications EP 0 322 834 and WO 91/14745. However, since the polyester contains chain ends which do not bear a reactive group, these ends do not participate in the formation of the three-dimensional network during the crosslinking of the powder, thus reducing the resistance to solvents and the flexibility of the coatings thus obtained.

The EP 1 054 917 claims to solve the above drawbacks of using a beta-hydroxyalkylamide as crosslinker by incorporation of tertiary carboxyl groups as reactive groups in the polyester resins. The said compositions provide coatings with excellent surface appearance, good flexibility and good resistance to poor weather conditions due to the lower reactivity and which induces a longer cure schedule.

As can be appreciated, it is not easy to find a thermosetting powder composition which by itself combines all the qualities which it would be desired to find therein, such as good stability in storage, good flowing when melting in order to give it a smooth, and glossy appearance which has no orange-peel skin or bubbles, good flexibility and good surface hardness, at the same time as good resistance to solvents, to aggressive weather exposure and all of this in a short curing time.

U.S. Pat. No. 6,284,845 suggests the use of other polyepoxide curing agents, but on the basis of the formulations set out in that specification, the performance parameters of the resulting powder compositions are not satisfactory as was possible with the use of triglycidyl isocyanurate. The principal purpose of U.S. Pat. No. 6,284,845 is to produce a material having a low cure temperature, specifically with curing temperatures as low as 121° C.

The present invention seeks to provide powder coating compositions exhibiting higher curing temperatures but which cure in dramatically shorter time periods and which fulfill the quality requirement of coating such as flow, flexibility and Health and Safety Executive (HSE) legislations.

We have found, surprisingly, that non-isocyanurate polyepoxide cross-linking reagents can be used, provided that of the carboxylated polyester resin is formed from at least 30 mole % aromatic acid relative to the total moles of carboxylic acid and the chain of the carboxyl terminated polyester also incorporates at least one moiety derived from 1,4 cyclohexanedicarboxylic acid.

According to one aspect of the present invention there is provided a polymeric composition suitable for use as a vehicle for a powder coating composition which comprises:

84 to 97 weight percent based on the weight of the polymeric vehicle, of (1) a carboxylated polyester resin which has an acid value in the range of 18 to 60 and a number average molecular weight in the range of 2000 to 11000, together with 3 to 15 weight percent based on the weight of (2) the polymeric vehicle of a non-isocyanurate polyepoxide or beta-hydroxyalkylamide, and (3) as a catalyst 0.05 to 2.0 percent by weight of e.g. an onium catalyst, characterized in that the carboxylated polyester resin contains at least 30% by mole of an aromatic di-acid in its chain and that in the respective components 1-3 proportions are selected to produce a curing time shorter than 90 seconds at a temperature of 250° C.

In a further aspect of the present invention, there is provided a carboxyl terminated polyester suitable for use in the formulation of a powder coating composition, which polyester is formed through the esterification or condensation reaction of a dicarboxylic acid of which at least 30 mole percent is an aromatic acid together with a diol, oxide or carbonate in an amount of up to 95 mole percent and further reacting the reaction product with a diacid in an amount of 5 mole percent to 20 mole percent to form a carboxylic polyester, characterized in that the dicarboxylic acid and/or the diacid anhydride comprises 1,4-cyclohexane dicarboxylic acid such that the total incorporated in the carboxyl terminated polyester is 0.1 to 25 mole percent and is selected to produce in the resultant resin an acid value within the range of 23 to 40, preferably 25 to 36, a viscosity within the range of 4000 to 16000 m·Pa·s measured at 200° C., and a glass transition temperature (Tg) greater than or equal to 57° C.

According to further embodiment of this invention, the polyester made by the condensation of a diacid and a diol contains also up to 4 mole percent of a polyol such as trimethylol propane or pentaerythritol.

In a further aspect of the present invention, there is provided a polymeric vehicle for a powder coating composition that can be cured for 90 seconds at a temperature of 250° C. or 55 seconds at 270° C. or 20 seconds in an induction oven at a temperature of 300° C. in the presence of a catalyst. The polymeric vehicle of the invention is formulated to provide a coating binder with desirable hardness, flexibility, solvent resistance, corrosion resistance, weatherability and gloss. The enhancement of these properties depends on the optimization and balancing of factors including monomer composition, T_{g} of the resin, type and amount of crosslinking agent, curing conditions, curing catalysts, and type and amount of pigments, fillers and additives. The reactivity and speed of cure is increased without sacrificing chemical storage stability or causing poor flow of the film due to pre-reaction of curing compound with polyester resin.

Moreover, the thermosetting powder coating compositions in accordance with the invention preserves all the advantages of the compositions containing TGIC as a cross-linking agent. The coatings compositions of this invention exhibit remarkable storage stability, smooth surface appearance, high gloss, and excellent mechanical properties which are maintained over time. It will be appreciated by skilled persons in the powder coating industry, that an excellent balance among weather-ability, mechanical properties and appearance imparted by the use of compositions in accordance with the invention are important factors of commercial importance.

The carboxylated polyester compositions to be used in this invention may be the reaction products of a hydroxyl terminated polyester and a diacid selected from the group consisting of adipic acid, azelaic acid, chlorendic acid, 1,3-cyclohexane dicarboxylic acid, 1,4-cyclohexane dicarboxylic acid, 1,4-cyclohexane dimethylcarboxylic acid, diglycolic acid, dimethyl terephthalic acid, dodecanedioic acid, fumaric acid, glutaric acid, hexahydrophthalic acid, isophthalic acid, maleic acid, succinic acid, tertiary butyl isophthalic acid, nadic acid, napthalene dicarboxylate, phthalic acid, sebacic acid, tetrachlorophthalic acid, their corresponding anhydrides, and mixtures thereof. The hydroxyl terminated polyester may be the esterification reaction product of diacid selected from the group consisting of isophthalic acid, terephthalic acid, 1,3-cyclohexane dicarboxylic acid, 1,4-cyclohexane dicarboxylic acid, 1,4-cyclohexane dimethylcarboxylic acid, adipic acid and mixtures thereof, preferably at least 30 mole percent of the aromatic acid is terephthalic, and a diol, an oxide or a carbonate. The diol may be selected from the group consisting of neopentyl glycol, cyclohexane dimethanol, 1,6 hexane diol, ethylene glycol, propylene glycol, 1,3-butylene glycol, 1,4-butane diol, pentane diol, hexylene glycol, diethylene glycol, dipropylene glycol, triethylene glycol, 2-butyl-2-ethyl diol, 1,3-propanediol, 2,2,4-trimethyl-1,3-pentane diol, hydrogenated bisphenol A, 1,3-pentane diol, 3-hydroxy-2,2-dimethyl propyl 3-hydroxy-2,2-dimethyl-propanoate, methyl propane diol, 2-methyl, 2-ethyl, 1,3-propane diol, vinyl cyclohexane diol and mixtures thereof. The oxide may be selected from the group consisting of ethylene oxide, propylene oxide, 1,2-butylene oxide, cyclohexane oxide and mixtures thereof. The carbonate may be selected from the group consisting of ethylene carbonate, propylene carbonate and mixtures thereof. Optionally, the esterification reaction may further include about 3 to about 10 mole percent of non aromatic diacid, from 2 to 5 mole percent of a polyacid, and from 0.01 to 4 mole percent of a polyol; the mole percent is on total acid or alcohol respectively.

The polyepoxide may have an average epoxy functionality of at least 2 but not more than 4 and an average epoxy equivalent weight in the range of 80 to 300.

The onium catalyst should be effective for curing times shorter than 90 seconds at a temperature of 250° C. Clearly, the higher the curing temperature, the shorter the curing period. The curing period is 55 seconds at 270° C. and is 20 seconds in an induction oven at a temperature of 300° C.

The resulting polymeric vehicle of the invention has a T_{g} of more than 57° C. and preferably more than 60° C., a viscosity of more than 4000 m·Pa·s but not more than 16 000 m·Pa·s at 200° C., which polymeric vehicle when crosslinked provides a coating binder having a pencil hardness of at least about HB, an impact resistance of 100 kg·cm and a 0T bend capability at a binder thickness of about 60-80 micrometers.

In another aspect of the present invention is formed by a process for the preparation of formulated powdered coating compositions comprising of mixing the carboxylated polyester as described herein with an epoxy compound and an onium catalyst and optionally with auxiliary substances conventionally used in the manufacture of powdered paints.

As used herein “coating binder” is the polymeric portion of a coating film after baking and after crosslinking.

“Polymeric vehicle” means all polymeric and resinous components including crosslinking agents in the formulated coating; i.e. before film formation. Pigments and additives may be mixed with the polymeric vehicle to provide a formulated powder coating composition.

“Diol” is a compound with two hydroxyl groups. “Polyol” is a compound with two or more hydroxyl groups.

“Diacid” is a compound with two carboxyl groups. “Polyacid” is a compound with two or more carboxyl groups.

As used in this application, “polymer” means a polymer with repeating monomeric units as defined herein.

A “film” is formed by application of the formulated coating composition to a base or substrate, and crosslinked.

“Oligomer” means a compound that is a polymer, but has a number average weight not greater than about 11,000 with or without repeating monomeric units.

Acid number or acid value means the number of milligrams of potassium hydroxide required for neutralization of free acids present in 1 g of resin. Hydroxyl number of value that is also called acetyl value is a number that indicates the extent to which a substance may be acetylated; it is the number of milligrams of potassium hydroxide required for neutralization of the acetic acid liberated on saponifying 1 g of acetylated sample.

The polyesters useful in the practice of the invention are thermosettable carboxyl terminated polymers, suitable for formulation of thermosetting powder coatings with non-cyanurate epoxide bearing compounds. This implies that the polyesters have a sufficiently high glass transition temperature to resist sintering when in powder form and subjected to normally encountered field conditions. The polyester of the present invention has a glass transition temperature T_{g} greater than or equal to 57° C., when determined by differential scanning calorimetry employing a heat-up rate of 10° C. per minute in a nitrogen atmosphere; the value is taken at the second run.

Both the T_{g} and melt viscosity of the resin are greatly influenced by the choice of monomers. An important aspect of the invention, the carboxylated polyester resin is made by a two-stage process. In stage one, hydroxyl terminated polyester is prepared, and in stage two, the hydroxyl terminated polyester is reacted with a diacid and/or an anhydride to form a carboxylated polyester.

In the preferred stage one, hydroxyl terminated polyester is formed through the esterification or condensation reaction of:
(1) a dicarboxylic acid selected from the group consisting of isophthalic acid (IPA), terephthalic acid (TPA) 1,4-cyclohexane dicarboxylic acid (CHDA), 1,4-cyclohexane dimethylcarboxylic acid and mixtures thereof, with at least about 30 mole percent of the aromatic acid being terephthalic; and
(2) a diol selected from the group consisting of neopentyl glycol, cyclohexane dimethanol, 1,6 hexane diol, ethylene glycol, propylene glycol, 1,3-butylene glycol, 1,4-butane diol, pentane diol, hexylene glycol, diethylene glycol, dipropylene glycol, triethylene glycol, 2-butyl-2-ethyl diol, 1,3-propanediol, 2,2,4-trimethyl-1,3-pentane diol, hydrogenated bisphenol A, 1,3-pentane diol, 3-hydroxy-2,2-diemthyl propyl 3-hydroxy-2,2-dimethyl-propanoate, methyl propane diol, 2-methyl, 2-ethyl, 1,3-propane diol, vinyl cyclohexane diol and mixtures thereof.

In another aspect of the invention, the aromatic acid can be reacted with oxides or with carbonates. The oxide may be selected from the group consisting of ethylene oxide, propylene oxide, 1,2-butylene oxide, cyclohexane oxide and mixtures thereof. The carbonate can be ethylene carbonate, propylene carbonate and mixtures thereof.

An important aspect of the invention is the very good mechanical properties of the carboxyl terminated polyester along with a high T_{g}, which can be obtained by introducing 1,4-cyclohexane dicarboxylic acid (CHDA) in the polymer backbone. The amount of CHDA, expressed as a molar percent of all the other acids constituting the polyester, is in the range of about 10 to about 40. A high T_{g} polyester in accordance with the invention permits the production of a stable powder paint using non cyanurate polyepoxide compounds such as triglycidyl trimellitate, diglycidyl terephthalate, diglycidyl isophthalate and relative mixtures like PT-910 and PT 912 (commercially available from HUNTSMAN, The Woodlands, Tex.).

According to another important aspect of the invention, the T_{g} of the polymeric vehicle may be optimized by controlling the ratio of diols present in the composition. The diols of the composition include neopentyl glycol, and a diol selected from the group consisting of cyclohexane dimethanol, 1,6 hexane diol, ethylene glycol, propylene glycol, 1,3-butylene glycol, 1,4-butane diol, pentane diol, hexylene glycol, diethylene glycol, dipropylene glycol, triethylene glycol, 2-butyl-2-ethyl diol, 1,3-propanediol, 2,2,4-trimethyl-1,3-pentane diol, hydrogenated bisphenol A, 1,3-pentane diol, 3-hydroxy-2,2-dimethyl propyl 3-hydroxy-2,2-dimethyl-propanoate, methyl propane diol, 2-methyl, 2-ethyl, 1,3-propane diol, vinyl cyclohexane diol, and mixtures thereof. The combination of neopentyl glycol and 1,3 propanediol in a molar ratio of about 70/30 as the diol moiety results in a polymeric vehicle with an acceptable T_{g}.

In an alternative aspect of the invention, neopentyl glycol can be replaced with a diol selected from the group consisting of 2-butyl-2-ethyl-1,3 propanediol (BEPD), 1,4 butane diol, 3-hydroxy-2,2-dimethyl propyl-3-hydroxy-2,2-dimethyl propionate, unoxol 6 diol, methyl propane diol, 2-methyl-1,3-propane diol (MPD), hydroxylpivalyl hydroxypivalate (HPHP), hydrogenated Bisphenol A and mixtures thereof, and addition of polyols, such as trimethylolpropane (TMP), trimethylolethane (TME), pentaerythritol (PE), ditrimethylolpropane (DI-TMP).

Optionally, the starting mixture for the esterification or condensation reaction may further include:
(a) from 0.01 to 5 mole percent of a polyacid selected from the group consisting of trimellitic anhydride (TMA), citric acid, and mixtures thereof; and
(b) from 0.01 to 4 mole percent of a polyol selected from trimethylol propane, trimethylolethane, pentaerythritol, ditrimethylolpropane, and mixtures thereof.

It will be appreciated that the incorporation of the polyacid or the polyol may be performed during the first step or in the second step of preparation of the present resin.

Furthermore the performance characteristics of the powder coating may be improved by the incorporation of additional monomers. For example, the use of an increased proportion of nonaromatic acids can improve flexibility and resistance to yellowing (as a result of exposure to ultraviolet radiation) compared to aromatic diacids.

The hydroxyl terminated polyester prepared in stage one typically has a hydroxyl value in the range of from about 15 to about 100, and preferably between about 25 and about 80.

In stage two, the hydroxyl terminated polyester prepared in stage one is reacted with a diacid to form the carboxylated polyester. As used herein, diacid means aliphatic or aromatic diacid, saturated or unsaturated acid or anhydride thereof. Suitable diacids include adipic acid, azelaic acid, chlorendic acid, 1,3-cyclohexane dicarboxylic acid, 1,4-cyclohexane dicarboxylic acid, diglycolic acid, dimethyl terephthalic acid, dodecanedioic acid, fumaric acid, glutaric acid, hexahydrophthalic acid, isophthalic acid, maleic acid, succinic acid, tertiary butyl isophthalic acid, nadic acid, napthalene dicarboxylate, phthalic acid, sebacic acid, tetrachlorophthalic acid, corresponding anhydrides and mixtures thereof.

As the number average molecular weight of the carboxylated polyester and the hydroxyl value of the hydroxyl terminated polyester vary, the number of equivalents of diacid necessary to react with the hydroxyl terminated polyester also will vary. The resulting carboxyl terminated polyester has an acid value in the range of from 18 to 60, and a number average molecular weight in the range of from 2000 to 11000.

The polyepoxy compounds that can be used for the preparation of thermosetting powder compositions according to the invention are the conventional non-isocyanurate containing polyepoxide compounds used in these types of compositions. The polyepoxide may have an average epoxy functionality of at least 2 but not more than about 4 and an epoxy equivalent weight of from about 80 to about 300. Examples of such epoxy resins include triglycidyl trimellitate, diglycidyl terephthalate, diglycidyl isophthalate and commercially available mixtures like PT-910 and PT 912 (commercially available from HUNTSMAN, The Woodlands, Tex.).

In a more preferred aspect of the invention, the polyepoxy compound may be PT 912 and is used in an amount of from about 3 to about 11 weight percent, based on the weight of the polymeric vehicle, preferably from about 0.8 to about 1.2 equivalent of epoxy groups per equivalent of carboxyl groups in the carboxyl terminated polyester. As the acid value of the carboxyl terminated polyester increases, more polyepoxide will be required to provide a suitable cured coating film.

The type and concentration of catalyst are important factors in obtaining the shorter reaction time at the stated temperatures. To reduce the curing temperature of carboxyl terminated polyester with polyepoxide, an onium compound is used as a catalyst. Examples include one or more of tetra butyl phosphonium bromide, triphenyl ethyl phosphonium bromide, butyl triphenyl phosphonium chloride, triphenyl ethyl phosphonium iodide, formyl methylene triphenyl phosphorane, formyl methyl triphenyl phosphonium chloride, benzolymethylene triphenyl phosphorane, phenyl triethyl phosphonium bromide, methoxy carbonyl methyl phosphonium bromide, ethyl triphenyl phosphoranylidene acetate, methyl triphenyl phosphoranylidene acetate, ethoxy carbonyl methyl triphenyl phosphonium bromide, ethyl triphenyl phosphonium acetate-acetic acid complex and mixtures thereof. Another important class of catalyst is the one containing primary, secondary and tertiary amine functional groups or the ammonium derivatives thereof.

The amount of catalyst employed depends upon the reactants used and the particular catalyst. In any event, the onium catalyst is added in an amount effective to provide for a curing time shorter than 90 seconds at a temperature of 250° C. Concentration of catalyst is an important factor in reducing curing time, and a concentration of onium catalyst of from 0.05 weight percent to 1.0 weight percent, based on the weight of the polymeric vehicle, has been found to be effective. In a preferred aspect of the invention, curing within the temperature/time parameters of the invention is achieved with a concentration of onium catalyst of 0.2 weight percent to about 0.5 weight percent, based on the weight of the polymeric vehicle. Preferably, the catalyst is added to the liquid melt of the carboxyl terminated polyester component prior to production of the powder. In another aspect of the invention, catalyst may be added to the paint formulation in an amount of up to 3.0 weight % of the formulation, and subsequently extruded.

An important benefit of the glycidyl trimellitate, diglycidyl terephthalate, diglycidyl isophthalate reactants and their blends, is the exceptionally clean toxicological profile which allows for the production of ultra-low toxicity powder coatings. Commercial product of such a class are represented by Araldite PT 910 (triglycidyl trimellitate (25%) diglycidyl terephthalate 75%) and Araldite PT 912 (triglycidyl trimellitate (40%) diglycidyl terephthalate 60%). The epoxy functionality is respectively 2.25 and 2.4. However, due to the presence of the triglycidyl trimellitate, which is a liquid at room temperature, the storage stability is worst (more sintering, more blocking of the powder) than with TGIC. Therefore the challenge for the skilled person in the art is to design the correct balance between reactivity, viscosity, T_{g} of the polyester resin to lead to a stable formulated powder and lead to a flexible good flowing cured film.

For the preparation of the thermosetting powder compositions of the invention, the carboxyl terminated polyester and the polyepoxide compound and various auxiliary substances conventionally used for the manufacture of powder paints and varnishes are mixed homogeneously. This homogenization is carried out for example by melting the polyester, the polyepoxide compound and the various auxiliary substances at a temperature within the range of from 90 to 100° C., preferably in an extruder, for example a Buss-Ko-Kneader extruder or a twin-screw extruder of the Werner-Pfleiderer or Baker Perkins type. The extrudate is then allowed to cool, and is ground and sieved to obtain a powder, having a particle size of 10 to 120 micrometers.

Another factor affecting viscosity and flow is the level of pigmentation and fillers in the system. High levels of pigmentation and/or fillers detract from the flow of the system by increasing the melt viscosity.

The auxiliary substances which can be added to the thermosetting compositions according to the invention include ultraviolet light absorbing compounds such as Tinuvin 928 (commercially available from CIBA-Specialties Chemicals, Tarrytown, N.Y.), light stabilizers based on sterically hindered amines (for example Tinuvin 144 commercially available from CIBA-Specialties Chemicals, Tarrytown, N.Y.), phenolic antioxidants (for example Irganox 1010 commercially available from CIBA-Specialties Chemicals, Tarrytown, N.Y.) and stabilizers of the phosphonite or phosphite type (for example Irgafos 168 or P-EPQ commercially available from CIBA-Specialties Chemicals, Tarrytown, N.Y.) (Tinuvin, Irganox, Irgafos are Trademarks). A variety of pigments may also be added to the thermosetting compositions according to the invention. Examples of pigments that may be employed in the invention are metal oxides such as titanium dioxide, iron oxide, zinc oxide and the like, metal hydroxides, metal powders, sulfides, sulfates, carbonates, silicates such as aluminum silicate, carbon black, talc, china clays, barytes, iron blues, lead blues, organic reds, organic maroons and the like. As auxiliary substances may also include flow control agents such as Fluidep F 630 (commercially available from COMIEL, Italy) Resiflow PV88 (commercially available from WORLEE, Hamburg, Germany), Modaflow (commercially available from Cytec, West Paterson, N.J.), Acronal 4F (commercially available from BASF, Florham Park, N.J.) (Fluidep, Resiflow, Modaflow, Acronal are trademarks) plasticizers such as dicyclohexyl phthalate, triphenyl phosphate, grinding aids, degassing agents such as benzoin and fillers. These auxiliary substances are added in conventional amounts, it being understood that if the thermosetting compositions of the inventions are used as clear coatings, opacifying auxiliary substances should be omitted.

The ground powder paint composition may be applied to the substrate by any of the known means of application. After coating, the deposited layer is cured by heating in an oven. While typically curing is effected at a temperature of 250° C. for 90 seconds in order to obtain sufficient crosslinking to provide the required coating properties, the compositions of the invention may be cured at lower temperature, for example by maintaining a temperature 160° C. for a prolonged period of the order of 20 minutes. It will be appreciated by the person skilled in the art that there is a balance between time and temperature for acceptable curing of the coating in that the higher the temperature, the shorter the curing period. Thus, for example, at a temperature of 180° C., the curing period is reduced to 10 minutes.

The decrease of curing time is economically and technically advantageous since it offers the possibility to work with lower reaction times and therefore in industrial ovens with reduced retention times (higher speed or smaller size). Another advantage of the invention is the possibility to achieve good coating properties in a Coil Coating Baking cycle using PT 912 as the curing agent.

Another advantage of the invention is that the coatings prepared from the compositions containing the polyesters according to the invention have a combination of outstanding properties. Improving the appearance of coatings applied as powders to be equivalent to the highest quality liquid coating finishes is an important consideration, and the present invention provides coatings with excellent appearance. While conventional coatings can be applied as relatively low viscosity liquids to give smooth films after removal of water and/or solvents, applied powder particles must melt, flow, wet the substrate, and coalesce and level to form a continuous film. The polymeric vehicle of the present invention is effective for providing a stable melt viscosity and flow.

While solvent/water based coatings can utilize polymer systems with a T_{g} even below room temperature, the T_{g} of a coating powder resin must be above 45° C. in order to possess acceptable non sintering characteristics. If the T_{g} of the coating is high enough, sintering can be avoided. However, coalescing and leveling at the lowest possible temperature are promoted by reducing T_{g}. For if the stability of the formulated composition to be maintained in storage without partial curing, then the T_{g} must be maintained at a sufficient level, i.e. greater than 57° C. The present invention optimizes T_{g} in combination with other factors to provide good coalescence and leveling of the coating prior to cure, whilst not sacrificing storage stability of the formulated powder coating.

The following examples should be understood to be illustrative of, but not limiting upon, the scope of the invention, which is defined in the appended claims.

### EXAMPLE 1

### Stage 1—Preparation of Hydroxyl Terminated Oligomer

| Reactant | Weight | |
|---|---|---|
| Neopentyl glycol | 5396 | g |
| Terephthalic acid | 6726 | g |
| Isophthalic acid | 897 | g |
| Monobutyltin Oxide | 6.5 | g |

This mixture was heated to 235° C. to an acid value of 11 with ICI plate and cone viscosity at 200° C. of 720 m·Pa·s. The hydroxyl number of this oligomer was found to be 63.

### Stage 2—Preparation of Carboxylic Acid Terminated Polyester

The above oligomer was cooled to 200° C. and added 1345 g of 1,4 cyclohexane dicarboxylic acid and 1 g of monobutyltin oxide were added. The temperature was raised to 225° C. When an acid value of 40.5 and ICI viscosity at 200° C. of 1480 m·Pa·s were obtained, 3 g of triphenylphosphite were added and vacuum was applied slowly over a 30-minute period until a vacuum of 75 mmHg was gradually established. The reaction was monitored by taking a sample and running the acid number and ICI cone and plate viscosity at 200° C. After an acid value of 28,1 28.1 and ICI viscosity at 200° C. of 8000 m·Pa·s were obtained, the melt was cooled down to 200° C. and 37.6 g of triphenyl ethyl phosphonium bromide catalyst and 37.6 g of tris(2,4-di-tert.-butylphenyl)phosphite were added and mixed into the resin for 30 minutes. After this period, the resin was discharged from the flask. The color of the resin was a light yellow in color. The final resin had an acid number of 27, ICI cone and plate viscosity at 200° C. of 8000 m·Pa·s, a glass transition temperature of 62° C. by DSC and Gardner Holdt color as a 50 wt. % solution in N-methyl-2-pyrrolidone of less than 1.

### EXAMPLE 2

### Stage 1—Preparation of Hydroxyl Terminated Oligomer

| Reactant | Weight | |
|---|---|---|
| Neopentyl glycol | 6832 | g |
| Trimethylolpropane | 30 | g |
| Terephthalic acid | 8559 | g |
| 1,4-cyclohexane dicarboxylic acid | 1812 | g |
| Monobutyltin Oxide | 14.3 | g |

The mixture was heated to 235° C. to an acid value of 16.9 with ICI plate and cone viscosity at 200° C. of 940 m·Pa·s. The hydroxyl number of this oligomer was found to be 41.

### Stage 2—Preparation of Carboxylic Acid Terminated Polyester

The above oligomer was cooled to 200° C. and added 1141 g of isophthalic acid and 4.8 g of monobutyltin oxide were added. The temperature was raised to 225° C. When an acid value of 46.1 and ICI viscosity at 200° C. of 1080 m·Pa·s were obtained, then 3.8 g of triphenylphosphite were added and vacuum applied slowly over a 30 minutes period until a vacuum of about 75 mmHg was gradually established. The reaction was monitored by taking a sample and running the acid number and ICI cone and plate viscosity at 200° C. After an acid value of 27.6 and an ICI viscosity at 200° C. of 8000 m·Pa·s were obtained, the melt was cooled down to 200° C. and 47.7 g of triphenyl ethyl phosphonium bromide catalyst and 47.7 g of tris(2,4-di-tert.-butylphenyl)phosphite were added and mixed into the resin for 30 minutes. After this period, the resin was discharged from the flask. The color of the resin is a light yellow in color. The final resin had an acid number of 27.6 ICI cone and plate viscosity at 200° C. of 7800 m·Pa·s, a glass transition temperature of 61.6° C. by DSC and a Gardner Holdt color as a 50 wt. % solution in N-methyl-2-pyrrolidone of less than 1.

### EXAMPLE 3

### Stage 1—Preparation of Hydroxyl Terminated Oligomer

| Reactant | Weight | |
|---|---|---|
| Neopentyl glycol | 6334 | g |
| Terephthalic acid | 7988 | g |
| 1,4-cyclohexane dicarboxylic acid | 1692 | g |
| Triphenylphosphite | 3.7 | g |
| Monobutyltin Oxide | 10.7 | g |

The mixture was heated to 235° C. to an acid value of 15.2 with ICI plate and cone viscosity at 200° C. of 1980 m·Pa·s. The hydroxyl number of this oligomer was found to be 37.

### Stage 2—Preparation of Carboxylic Acid Terminated Polyester

The above oligomer was cooled to 200° C. and added 1188 g of isophthalic acid with 36 g of trimethylolpropane were added. The temperature was raised to 225° C. When an acid value of 44.5 and ICI viscosity at 200° C. of 2140 m·Pa·s were obtained, then 3.4 g of triphenylphosphite were added and vacuum applied slowly over a 30 minutes period until a vacuum of about 75 mmHg was gradually established. The reaction was monitored by taking a sample and running the acid number and ICI cone and plate viscosity at 200° C. After an acid value of 35,1 35.1 and an ICI viscosity at 200° C. of 4900 m·Pa·s were obtained the melt was cooled down to 200° C. and 44.9 g of triphenyl ethyl phosphonium bromide catalyst and 44.9 g of tris(2,4-di-tert-butylphenyl)phosphite were added and mixed into the resin for 30 minutes. After this period, the resin was discharged from the flask. The color of the resin is a light yellow in color. The final resin had an acid number of 35.0 ICI cone and plate viscosity at 200° C. of 5000 m·Pa·s, a glass transition temperature of 61.1° C. by DSC and a Gardner Holdt color as a 50 wt. % solution in N-methyl-2-pyrrolidone of less than 1.

### EXAMPLE 4

### Comparative

According to procedure of example 1 in order to compare them with the existing “state of the art” polymer was synthesized example 4 in the same lab equipment in order to test commercial polyester in this particular application.

### Stage 1—Preparation of Hydroxyl Terminated Oligomer

| Reactant | Weight | |
|---|---|---|
| Neopentyl glycol | 6985 | g |
| Trimethylolpropane | 70 | g |
| Terephthalic acid | 9490 | g |
| Adipic Acid | 393 | g |
| Monobutyltin Oxide | 13.7 | g |
| Triphenilphosphite | 9.1 | g |

This mixture was heated to 245° C. to an acid value of 8.7 with ICI plate and cone viscosity at 200° C. of 450 m·Pa·s.

### Stage 2—Preparation of Carboxylic Acid Terminated Polyester

The above oligomer was cooled to 220° C. and added 11.7 g of triphenylphosphite, 1744 g of isophthalic acid and 5.9 g of monobutyltin oxide. The temperature was raised to 225° C. after an acid value of 38 and ICI viscosity at 200° C. of 1280 m·Pa·s were obtained, the melt was cooled down to 200° C., and vacuum was applied slowly over a 30 minutes period until a vacuum of 75 mmHg was gradually established. The reaction was monitored by taking a sample and running the acid number and ICI cone and plate viscosity at 200° C. After an acid value of 24.9 and ICI viscosity at 200° C. of 8000 m·Pa·s were obtained, the melt was cooled down to 200° C. and 48.8 g of triphenyl ethyl phosphonium bromide catalyst and 48.7 g of tris(2,4-di-tert.-butylphenyl)phosphite were added and mixed into the resin for 30 minutes. After this period, the resin was discharged from the flask. The color of the resin was a light yellow in color. The final resin had an acid number of 24.4 with ICI cone and plate viscosity at 200° C. of 8100 m·Pa·s, a glass transition temperature of 63.3° C. by DSC and Gardner Holdt color as a 50 wt. % solution in N-methyl-2-pyrrolidone of less than 1.

### EXAMPLE 5

### Preparation of Powder Coatings

A series of powder coatings is prepared from the polyesters obtained in Examples 1 to 4 according to the following two different formulations, one having a binder:crosslinking agent ratio of 93:7 (formulation A) and the other having a binder:crosslinking agent ratio of 91:9 (formulation B). All polyesters were evaluated by the following method. The granulated polyester resin (binder) was dry mixed with Araldite PT 912, 8.8 g Fluidep F 630 (commercially available from Siri S.p.A., Italy), 2.5 g benzoin and 168 g of titanium dioxide (Kronos 2160, commercially available from Kronos, Chelmsford, Mass.) and subsequently introduced into an extruder (APV mod MP 30). The extrudate was cooled, ground and sieved. The sieved fraction smaller than 105 microns was collected and used as the powder coating. This powder coating was electrostatically sprayed onto steel panels. The physical properties of the formulated powder coating are determined after a 1 minute and 30 seconds cure at 250° C. at a coating thickness of 60 to 80 micrometers. The compositions and the test results of these powder coatings are given in Table 1.

BAKE SCHEDULE: 1 minute 30 seconds at 250° C.

Formulation A (weight %) for examples 1-2-4

| | |
|---|---|
| Polyester Resin | 298.2 |
| PT 912 | 22.5 |
| Fluidep F 630 | 8.8 |
| Benzoin | 2.5 |
| Titanium dioxide | 168 |

Formulation B (weight %) for example 3

| | |
|---|---|
| Polyester Resin | 295.7 |
| PT 912 | 29.3 |
| Fluidep F 630 | 8.8 |
| Benzoin | 2.5 |
| Titanium dioxyde | 168 |

TABLE 1

| | | | | Ex. 4 |
|---|---|---|---|---|
| Coating Properties | Ex. 1 | Ex. 2 | Ex. 3 | Comp. |
| Thickness (μ) | 60-70 | 60-70 | 60-70 | 60-70 |
| Appearance | Good | Good | Good | Good |
| Gloss at 60°/20° (%) | 93/78 | 93/76 | 93/81 | 96/76 |
| * Impact Dir/Rev (Kg.c | 160/160 | 160/160 | 100/80 | 50/50 |
| 0T Bending | Pass | Pass | Pass | Fail |

* Impact resistance evaluated according ASTM D 2794.

These results clearly show that the thermosetting powder compositions in according with the invention have advantageous characteristics compared to those obtained from compositions of the prior art based on carboxyl terminated polyesters which do not incorporate 1,4-cyclohexane dicarboxylic acid in the polymer's structure.

The commercial polyester resin fails to cure at any of the temperatures as seen by the results of the 0T bend test and impact resistance.

Numerous modifications and variations in practice of the invention are expected to occur to those skilled in the art upon consideration of the foregoing detailed description of the invention. Consequently, such modifications and variations are intended to be included within the scope of the following claims.

1. A polymeric composition comprising:
(1) 84 to 97 weight percent, relating to the weight of the polymeric composition, of a carboxylated polyester resin which has an acid value in the range of from 18 to 60, a number average molecular weight in the range of from 2000 to 11000, and a glass transition temperature greater than or equal to 57° C.,
(2) 3 to 15 weight percent based on the weight of the polymeric composition, of a non-isocyanurate polyepoxide or a beta-hydroxyalkylamide and
(3) 0.05 to 2.0 weight percent of a catalyst effective for producing a curing time shorter than 90 seconds at a temperature of 250° C.

2. The polymeric composition of claim 1, wherein the non-isocyanurate polyepoxide has an average epoxy functionality of not more than 4 and an average epoxy equivalent weight in the range of from 80 to 300.

3. The polymeric composition of claim 1, wherein the carboxylated polyester resin is formed from at least 30 mole % of aromatic acid relative to the total acid content employed for the formation of the carboxylated polyester resin.

4. The polymeric composition of claim 1, wherein the carboxylated polyester resin includes a moiety derived from 0.1 to 25% by mole of 1,4-cyclohexane dicarboxylic acid.

5. The polymeric composition of claim 1, wherein the epoxy compound is selected from the group consisting of triglycidyl trimellitate, diglycidyl terephthalate, diglycidyl isophthalate and combinations thereof.

6. The polymeric composition of claim 1, wherein the catalyst is selected from the group consisting of tetra butyl phosphonium bromide, triphenyl ethyl phosphonium bromide, butyl triphenyl phosphonium chloride, triphenyl ethyl phosphonium iodide, formyl methylene triphenyl phosphorane, formyl methyl triphenyl phosphonium chloride, benzolymethylene triphenyl phosphorane, phenyl triethyl phosphonium bromide, methoxy carbonyl methyl phosphonium bromide, ethyl triphenyl phosphoranylidene acetate, methyl triphenyl phosphoranylidene acetate, ethoxy carbonyl methyl triphenyl phosphonium bromide, ethyl triphenyl phosphonium acetate-acetic acid complex and combinations thereof.

7. The polymeric composition of claim 1, wherein the polyester is the esterification reaction product of diacid selected from the group consisting of isophthalic acid, terephthalic acid, 1,3-cyclohexane dicarboxylic acid, 1,4-cyclohexane dicarboxylic acid, 1,4-cyclohexane dimethylcarboxylic acid, adipic acid and combinations thereof, with at least about 30 mole percent of the aromatic acid being terephthalic, and a diol, an oxide or a carbonate.

8. The polymeric composition of claim 7, wherein the esterification reaction product further includes 3 to 10 mole percent of a non aromatic diacid, 0.01 to 5 mole percent of a polyacid, and from 0.01 to 4 mole percent of a polyol.

9. A carboxylated polyester composition for use in a powder coating formulations comprising a carboxylated reaction product of a dicarboxylic acid with a diol, oxide and/or carbonate
wherein the dicarboxylic acid comprises at least 30 weight % of aromatic acid and 0.1 to 25% of 1,4-cyclohexane dicarboxylic acid, and
wherein the carboxylated reaction product has an acid number within the range from 23 to 40, a viscosity from 4000 to 16000 m·Pa·s at 200° C. and a glass transition temperature greater than or equal to 57° C.

10. The polymeric composition of claim 1, wherein the polymeric composition is a cured film coating a coated article.

11. The carboxylated polyester composition of claim 9, wherein the carboxylate polyester composition is a cured film coating a coated article.

12. The polymeric composition of claim 1, wherein the non-isocyanurate polyepoxide has an average epoxy functionality of at least 2.

13. The polymeric composition of claim 7, wherein the diol is selected from the group consisting of neopentyl glycol, cyclohexane dimethanol, 1,6 hexane diol, ethylene glycol, propylene glycol, 1,3-butylene glycol, 1,4-butane diol, pentane diol, hexylene glycol, diethylene glycol, dipropylene glycol, triethylene glycol, 2-butyl-2-ethyl diol, 1,3-propanediol, 2,2,4-trimethyl-1,3-pentane diol, hydrogenated bisphenol A, 1,3-pentane diol, 3-hydroxy-2,2-dimethyl propyl 3-hydroxy-2,2-dimethyl-propanoate, methyl propane diol, 2-methyl, 2-ethyl, 1,3-propane diol, vinyl cyclohexane diol, and combinations thereof.
